(19) United States
(12) Patent Application Publication
(10) Pub. No.: US 2019/0044760 A1
(43) Pub. Date: Feb. 7, 2019

(54) TECHNOLOGIES FOR OPTIMIZING TRANSMITTER EQUALIZATION WITH HIGH-SPEED RETIMER

(71) Applicant: Intel Corporation, Santa Clara, CA (US)

(72) Inventors: Allen Chiang, Taipei (TW); Anita Yang, Taipei (TW); Mike Chen, Kaohsiung City (TW); Aaron Chang, Taipei City (TW)

(21) Appl. No.: 16/013,292

(22) Filed: Jun. 20, 2018

(51) Int. Cl. H04L 25/03; H04L 29/06; G06F 13/42

(52) U.S. Cl. CPC H04L 25/03343; H04L 25/03878; H04L 1/24; G06F 13/4291; H04L 69/28

(57) ABSTRACT

Technologies for optimizing transmitter equalization include a computing device having a data port and a retimer. The retimer includes two serial data links, a clock recovery device, and a signal repeater. One serial data link of the retimer is connected to the data port. A bit-error rate test instrument (BERT) is connected to the other serial data link of the retimer and sweeps through multiple transmitter equalization settings while sending a compliance pattern. The retimer sends back the compliance pattern in a loopback mode. The BERT measures bit-error rate data, and an optimized transmitter equalization setting is determined based on the bit-error rate data. An end device may be configured with the optimized transmitter equalization setting and may be connected to the retimer instead of the BERT. The data port may be a PCI Express port or a backplane Ethernet port. Other embodiments are described and claimed.

### BACKGROUND

Typical computing devices may include one or more high-speed serial digital data links, such as peripheral links, network links, or other high-speed serial communication links. Techniques for improving signal integrity become more important as data rates increase. Certain computing devices may incorporate one or more retimers to improve signal integrity.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for optimizing transmitter equalization;

FIG. 2 is a simplified block diagram of at least one embodiment of an environment of a computing device of FIG. 1;

FIG. 3 is a simplified block diagram of at least one embodiment of serial communication that may be established by the system of FIGS. 1-2;

FIG. 4 is a simplified block diagram of at least one embodiment of serial communication that may be established by the system of FIGS. 1-2;

FIG. 5 is a simplified flow diagram of at least one embodiment of a method for optimizing transmitter equalization that may be executed by the system of FIGS. 1-2; and

FIG. 6 is an illustrative bit-error rate diagram that may be generated by the system of FIGS. 1-2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

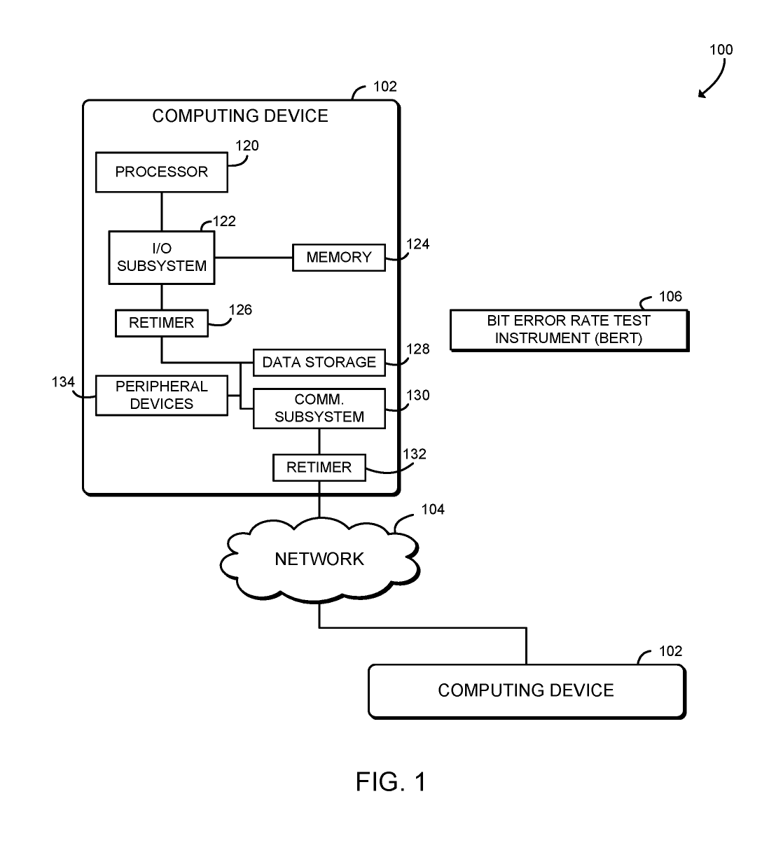

Referring now to FIG. 1, a system 100 for optimizing transmitter equalization includes a computing device 102 that may be in communication with other computing devices 102 over a network 104. The computing device 102 illustratively includes one or more retimers 126, 132 that are connected to high-speed serial data links. In use, as described further below, one serial link of a retimer 126, 132 is connected to a data port, and the other serial link is connected to a bit error rate test instrument (BERT) 106. The BERT 106 sweeps through multiple transmitter equalization settings while measuring bit-error rate data. Optimized transmitter equalization settings are determined based on the bit-error rate data, and those optimized equalization settings are applied to an end device that is connected to the retimer 126, 132 by the serial link instead of the BERT 106, such as a peripheral device or a remote computing device 102. By applying optimized transmitter equalization settings to the end device, the system 100 may improve signal margin for the serial link connected to the end device. Additionally, the system 100 may improve signal margin over existing systems that include a retimer, because existing data ports may only be capable of determining optimized equalization settings for the data link connected directly between the data port and the retimer, and not for the data link connected between the retimer and the end device.

The computing device 102 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. As shown in FIG. 1, the computing device 102 illustratively include a processor 120, an input/output subsystem 122, a memory 124, a data storage device 128, and a communication subsystem 130, and/or other components and devices commonly found in a server or similar computing device. Of course, the computing device 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the computing device 102 such operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 102. For example, the I/O subsystem 122 may be embodied as, or otherwise include, memory controller hubs, input/output control hubs, sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 102, on a single integrated circuit chip.

The data storage device 128 may be embodied as any type of device or devices configured for short-term or long-term storage of data such as, for example, memory devices and circuits, memory cards, hard disk drives, solid-state drives, non-volatile flash memory, or other data storage devices. The computing device 102 also includes the communication subsystem 130, which may be embodied as any communication circuit, device, or collection thereof, capable of enabling communications between the computing device 102 and other remote devices over the network 104. For example, the communication subsystem 130 may be embodied as or otherwise include a network interface controller (NIC) for sending and/or receiving network data with remote devices. The communication subsystem 130 may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication.

The computing device 102 may further include one or more peripheral devices 134. The peripheral devices 134 may include any number of additional input/output devices, interface devices, and/or other peripheral devices. For example, in some embodiments, the peripheral devices 134 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

As shown in FIG. 1, the computing device 102 also includes one or more retimers 126, 132. Each retimer 126, 132 may be embodied as any analog and/or digital logic circuit, component, or other device configured to receive and recognize serial digital data and then re-transmit that serial data to another device. Thus, the retimer 126, 132 may boost the received signal to compensate for channel loss. For example, each retimer may include a clock recovery circuit or other device, a signal repeater, a receiver equalizer, and/or a transmit equalizer. By receiving and recognizing symbols in the incoming serial signal (including performing receiver equalization) and then repeating the signal, the retimer may improve overall signal integrity and margin. As shown in FIG. 1, the retimer 126 is coupled between the I/O subsystem 122 and one or more other devices, such as the data storage device 128, communication subsystem 130, and/or peripheral devices 134. For example, the retimer 126 may be embodied as a PCI Express retimer and may be connected to the I/O subsystem 122 and to other devices 128, 130, 134 by PCI Express serial links. FIG. 1 further illustrates that the retimer 132 may be coupled between the communication subsystem 130 and the network 104. For example, the retimer 132 may be embodied as an Ethernet retimer, and may be connected to the communication subsystem 130 and to the network 104 by Ethernet backplane serial links. Although illustrated as including two retimers 126, 132, of course in other embodiments the computing device 102 may include a different number and/or arrangement of retimers, which each may be coupled between a data port logic and end device via serial data links.

The computing device 102 may be configured to transmit and receive data with other computing devices 102 and/or other devices over the network 104. The network 104 may be embodied as any number of various wired and/or wireless networks. For example, the network 104 may be embodied as, or otherwise include, a wired or wireless local area network (LAN), and/or a wired or wireless wide area network (WAN). As such, the network 104 may include any number of additional devices, such as additional computers, routers, and switches, to facilitate communications among the devices of the system 100. In the illustrative embodiment, the network 104 is embodied as a local Ethernet network.

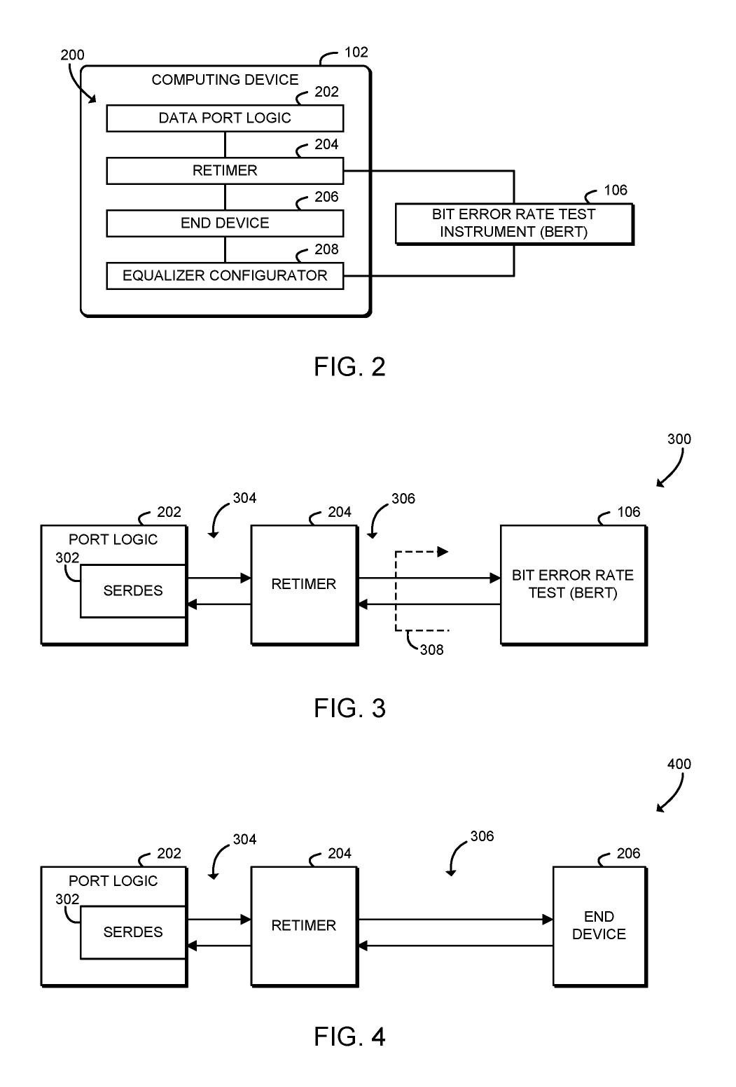

Referring now to FIG. 2, in an illustrative embodiment, the computing device 102 establishes an environment 200 during operation. The illustrative environment 200 includes a data port logic 202, a retimer 204, an end device 206, and an equalizer configurator 208. The various components of the environment 200 may be embodied as hardware, firmware, software, or a combination thereof. As such, in some embodiments, one or more of the components of the environment 200 may be embodied as circuitry or a collection of electrical devices (e.g., data port logic circuitry 202, retimer circuitry 204, end device circuitry 206, and/or equalizer configurator circuitry 208). It should be appreciated that, in such embodiments, one or more of the data port logic circuitry 202, the retimer circuitry 204, the end device circuitry 206, and/or the equalizer configurator circuitry 208 may form a portion of the processor 120, the I/O subsystem 122, the communication subsystem 130, the retimer 126, 132, and/or other components of the computing device 102. Additionally, in some embodiments, one or more of the illustrative components may form a portion of another component and/or one or more of the illustrative components may be independent of one another.

The data port logic 202 may be embodied as any data port of the computing device 102 that communicates via one or more serial data links. The data port logic 202 may be embodied as a PCI Express port (e.g., a PCI Express switch, root complex, or other PCI Express port), an Ethernet port, or other data port of the computing device 102. Thus, the data port logic 202 may be embodied as and/or incorporated in the I/O subsystem 122 and/or the communication subsystem 130. Each serial data link may include a transmit differential signaling pair and a receive differential signaling pair. For example, each serial data link may include one or more PCI Express lanes, backplane Ethernet lanes, or other full-duplex differential signaling pairs.

The equalizer configurator 208 is configured to connect a bit error rate test instrument (BERT) 106 to a serial data link of the retimer 204. The equalizer configurator 208 is further configured to cause the BERT 106 to send a compliance pattern to the retimer via the serial data link, to cause the BERT 106 to sweep through a plurality of transmitter equalization settings while sending the compliance pattern, and to cause the BERT 106 to measure bit-error rate data in response to sweeping through the plurality of transmitter equalization settings. The equalizer configurator 208 is further configured to identify an optimized transmitter equalization setting based on the bit-error rate data. The equalizer configurator 208 may be configured to generate a bit-error rate diagram based on the bit-error rate data, and to identify the optimized transmitter equalization settings based on the bit-error rate data. The BERT 106 may be embodied as a separate computing device, link analyzer, test instrument, or other device. Additionally or alternatively, in some embodiments the BERT 106 may be incorporated in the computing device 102. The equalizer configurator 208 may be further configured to disconnect the BERT 106 from the serial data link, configure the end device 206 with the optimized transmitter equalization setting, and then connect the end device 206 to the serial data link.

The end device 206 may be embodied as any peripheral device, remote computing device, or other device that may be connected to the retimer 204 via a serial data link. The retimer 204 is configured to repeat the compliance pattern received from the BERT 106 back to the BERT 106 in a loopback mode. The retimer 204 may be embodied as the retimer 126, 132 and/or other retimer of the computing device 102.

Referring now to FIG. 3, diagram 300 illustrates an arrangement for serial data communication that may be established by the system 100. As shown, the data port logic 202 includes a serializer/deserializer (serdes) 302 that is coupled to a serial data link 304. Of course, the data port logic 202 may also include additional equalizers and/or other communication logic, not shown in FIG. 3. The serial data link 304 is coupled to the retimer 204. The retimer 204 is also coupled to a serial data link 306. The serial data link 306 is coupled to the BERT 106. As described further below, the BERT 106 may transmit a compliance pattern over the serial data link 306 to the retimer 204. The retimer 204 may repeat that compliance pattern back to the BERT 106 over the serial data link 306, illustrated as a loopback mode operation 308.

Referring now to FIG. 4, diagram 400 illustrates another arrangement for serial data communication that may be established by the system 100. Similar to the arrangement of FIG. 3, as shown in FIG. 4 the serdes 302 of the data port logic 202 is coupled to the serial data link 304, which is coupled to the retimer 204. The retimer 204 is coupled to the serial data link 306, and the serial data link 306 is coupled to the end device 206. As described further below, the end device 206 may be configured with transmitter equalization settings determined using the arrangement as shown in FIG. 3. After configuration, the end device 206 may communicate with the data port logic 202 via the retimer 204.

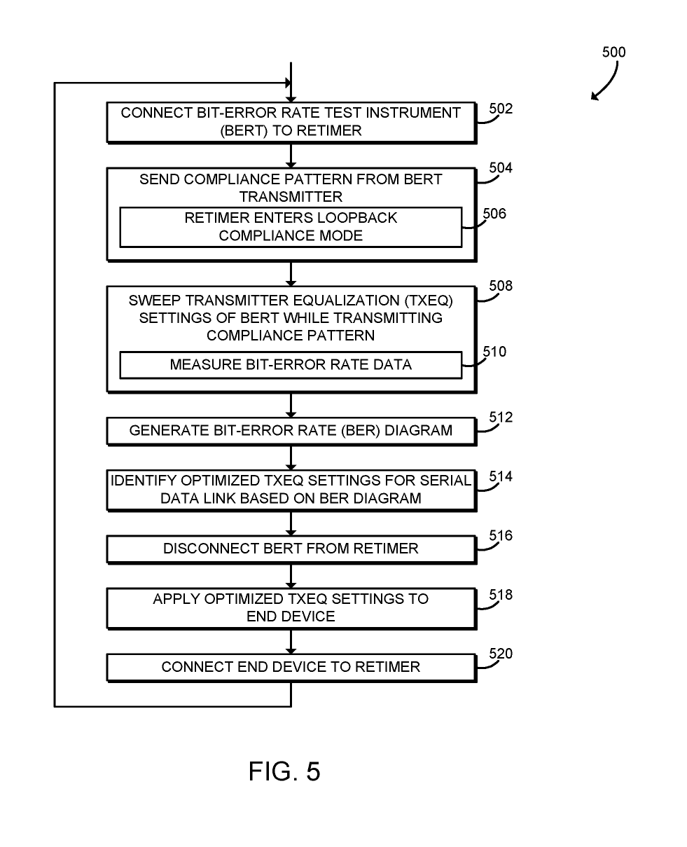

Referring now to FIG. 5, in use, the computing device 102 may execute a method 500 for optimizing transmitter equalization. It should be appreciated that, in some embodiments, the operations of the method 500 may be performed by one or more components of the environment 200 of the computing device 102 as shown in FIG. 2. The method 500 begins in block 502, in which the computing device 102 connects to the bit-error rate test instrument (BERT) 106 to a retimer 204. The computing device 102 may connect the BERT 106 to any retimer 204 of the computing device 102, such as the retimer 126, the retimer 132, and/or other retimer. The BERT 106 may be connected to the retimer 204 automatically, for example using electronically controlled switching, or in some embodiments may be connected by an operator of the computing device 102.

In block 504, the BERT 106 sends a compliance pattern from a transmitter of the BERT 106 to the retimer 204. The compliance pattern may be embodied as any predetermined pattern of electrical signals that is sent over the serial data link 306 for testing and/or diagnostic purposes. The BERT 106 may be commanded or otherwise caused to transmit the compliance pattern by the computing device 102 or in some embodiments by the operator of the computing device 102. In block 506, in response to the BERT 106 sending the compliance pattern, the retimer 204 enters a loopback compliance mode. In the loopback compliance mode, as illustrated in FIG. 4, the retimer 204 receives and recognizes the compliance pattern, for example by recovering a clock signal using clock recovery circuitry and recognizing symbols transmitted by the BERT 106, for example using a continuous time linear equalizer, decision-feedback equalizer, or other receiver equalization circuitry. After recognizing the pattern, the retimer 204 retransmits the received compliance pattern back to the BERT 106 via the serial data link 306.

In block 508, the BERT 106 sweeps between multiple transmitter equalization (TXEQ) settings while transmitting the compliance pattern. The BERT 106 may include a finite-impulse response equalizer or other transmitter equalization circuitry. The TXEQ settings may include transmitter pre-cursor and post-cursor coefficients or other parameters of the transmitter equalization circuitry that may be configured to compensate for channel loss between the BERT 106 and the retimer 204. The BERT 106 may be commanded or otherwise caused to sweep through the TXEQ settings by the computing device 102 or in some embodiments by the operator of the computing device 102. In block 510, the BERT 106 measures bit-error rate data while sweeping through the TXEQ settings. For example, the BERT 106 may identify bit errors by comparing symbols received from the retimer 204 in loopback compliance mode to the expected symbols of the compliance pattern. The BERT 106 may collect bit-error rate data for each TXEQ setting that is tested.

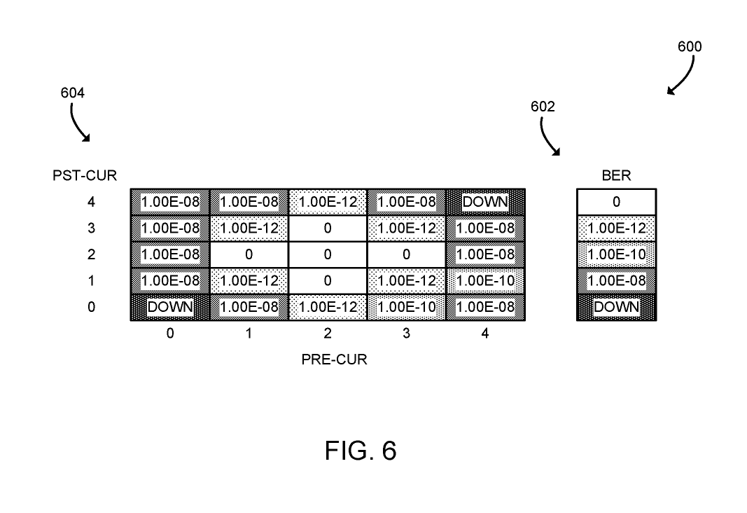

In block 512, the system 100 generates a bit-error rate (BER) diagram. The bit-error rate diagram illustrates BER for the tested TXEQ settings as measured by the BERT 106. The BER diagram may be generated by the BERT 106, or in some embodiments by the computing device 102. One potential embodiment of a BER diagram is illustrated in FIG. 6 and described below.

In block 514, the system 100 identifies optimized TXEQ settings for the serial data link 306 based on the measured BER data and/or the BER diagram. The system 100 may identify the TXEQ settings with the lowest measured BER. If multiple TXEQ settings have the lowest measured BER (e.g., a measured BER of zero), the system 100 may identify TXEQ settings at the center of an area of the diagram with the lowest measured BER. Selecting the center of the area with the lowest BER may provide the greatest signal integrity margin. The optimized TXEQ settings may be identified automatically by the computing device 102, or in some embodiments may be identified by an operator of the computing device 102, for example using a visual display of the BER diagram.

In block 516, the BERT 106 is disconnected from the retimer 204. As described above, the BERT 106 may be disconnected automatically, for example using electronically controlled switching, or in some embodiments may be disconnected by the operator of the computing device 102.

In block 518, the optimized TXEQ settings are applied to an end device, such as a peripheral device 134 or a remote computing device 102 (e.g., to the communication subsystem 130, the retimer 132, or other transmitter circuitry of the remote computing device 102). For example, the optimized pre-cursor and post-cursor coefficients may be used to configure a finite impulse response equalizer or other equalizer circuitry of the end device. The end device may be configured automatically by the computing device 102 or in some embodiments by an operator of the computing device 102 and/or system 100.

In block 520, the end device is connected to the retimer 204 via the serial data link 306, as shown in FIG. 4. Similar to the BERT 106, the end device may be connected to the retimer 204 automatically, for example using electronically controlled switching, or in some embodiments may be connected by an operator of the computing device 102. After being connected to the retimer 204, the end device communicates with the data port logic 202 via the retimer 204 and the serial data links 304, 306. The end device communicates over the serial data link 306 using the optimized TXEQ settings determined as described above. Although those optimized TXEQ settings were determined using the serial data link arrangement as shown in FIG. 3, the optimized TXEQ settings also improve signal integrity margin for the serial data link 306 in the arrangement as shown in FIG. 4. Thus, the system 100 may provide improved signal integrity, improved margin, or otherwise improved communications speed and/or accuracy as compared to systems with retimers that do not optimize TXEQ settings for the end device. After connecting the end device, the method 500 loops back to block 502, in which the system 100 may perform additional transmitter equalization optimization.

Referring now to FIG. 6, diagram 600 illustrates a bit-error rate (BER) diagram that may be generated by the system 100. As shown in legend 602, the measured bit-error rate may vary from zero (i.e., no measured errors) to link-down (i.e., so many bit errors that the link is effectively not available). Table 604 illustrates measured BER data for various combinations of TXEQ settings swept by the BERT 106. The vertical axis of the table 604 corresponds to post-cursor coefficients of values zero to four, and the horizontal axis of the table 604 corresponds to pre-cursor coefficient values of zero to four. As shown, the table 604 includes an area with the lowest BER (i.e., zero) centered at pre-cursor coefficient equal to two and post-cursor coefficient equal to two. Thus, in the illustrative example, the optimized TXEQ settings are a pre-cursor coefficient equal to two and a post-cursor coefficient equal to two. Those TXEQ settings may provide the largest margin for an end device connected to the same serial data link.

It should be appreciated that, in some embodiments, the method 500 may be embodied as various instructions stored on a computer-readable media, which may be executed by the processor 120 and/or other components of the computing device 102 to cause the computing device 102 to perform the method 500. The computer-readable media may be embodied as any type of media capable of being read by the computing device 102 including, but not limited to, the memory 124, the data storage device 128, firmware devices, other memory or data storage devices of the computing device 102, portable media readable by a peripheral device 134 of the computing device 102, and/or other media.

### EXAMPLES

Illustrative examples of the technologies disclosed herein are provided below. An embodiment of the technologies may include any one or more, and any combination of, the examples described below.

Example 1 includes a computing device for transmitter equalization configuration, the computing device comprising: a data port; a retimer that includes a first serial data link, a second serial data link, a clock recovery device, and a signal repeater, wherein the signal repeater is coupled between the first serial data link and the second serial data link, and wherein the second serial data link is connected to the data port; and an equalizer configurator to: (i) connect a bit error rate test instrument (BERT) to the first serial data link of the retimer, (ii) cause the BERT to send a compliance pattern to the retimer via the first serial data link, (iii) cause the BERT to transmit with a plurality of transmitter equalization settings while sending the compliance pattern, (iv) cause the BERT to measure bit-error rate data in response to transmission with the plurality of transmitter equalization settings; and (v) identify a transmitter equalization setting based on the bit-error rate data; wherein the retimer is to repeat the compliance pattern to the BERT via the first serial data link in a loopback mode in response to sending of the compliance pattern.

Example 2 includes the subject matter of Example 1, and wherein each of the first serial data link and the second serial data link comprises a transmit differential signaling pair and a receive differential signaling pair.

Example 3 includes the subject matter of any of Examples 1 and 2, and wherein the equalizer configurator is further to: disconnect the BERT from the first serial data link; configure an end device with the transmitter equalization setting; and connect the end device to the first serial data link.

Example 4 includes the subject matter of any of Examples 1-3, and wherein the computing device comprises the end device, and wherein the end device comprises a peripheral device.

Example 5 includes the subject matter of any of Examples 1-4, and wherein the end device comprises a remote computing device.

Example 6 includes the subject matter of any of Examples 1-5, and wherein the equalizer configurator is further to: generate a bit-error rate diagram based on the bit-error rate data; wherein to identify the transmitter equalization setting comprises to identify the transmitter equalization setting based on the bit-error rate diagram.

Example 7 includes the subject matter of any of Examples 1-6, and wherein the first serial data link comprises an electrical backplane link.

Example 8 includes the subject matter of any of Examples 1-7, and wherein the first serial data link comprises a PCI Express lane, the second serial data link comprises a PCI Express lane, and the data port comprises a PCI Express port.

Example 9 includes the subject matter of any of Examples 1-8, and wherein the first serial data link comprises an Ethernet lane, the second serial data link comprises an Ethernet lane, and the data port comprises an Ethernet port.

Example 10 includes the subject matter of any of Examples 1-9, and wherein the transmitter equalization setting comprises a pre-cursor setting and a post-cursor setting.

Example 11 includes a method for transmitter equalization configuration, the method comprising: connecting a bit error rate test instrument (BERT) to a first serial data link of a retimer, wherein the retimer comprises the first serial data link, a second serial data link, a clock recovery device, and a signal repeater, wherein the signal repeater is coupled between the first serial data link and the second serial data link, and wherein the second serial data link is connected to a data port; sending, by the BERT, a compliance pattern to the retimer via the first serial data link; repeating, by the retimer, the compliance pattern to the BERT via the first serial data link in a loopback mode; transmitting, by the BERT, with a plurality of transmitter equalization settings while sending the compliance pattern; measuring, by the BERT, bit-error rate data in response to transmitting with the plurality of transmitter equalization settings; and identifying a transmitter equalization setting based on the bit-error rate data.

Example 12 includes the subject matter of Example 11, and wherein each of the first serial data link and the second serial data link comprises a transmit differential signaling pair and a receive differential signaling pair.

Example 13 includes the subject matter of any of Examples 11 and 12, and further comprising: disconnecting the BERT from the first serial data link; configuring an end device with the transmitter equalization setting; and connecting the end device to the first serial data link.

Example 14 includes the subject matter of any of Examples 11-13, and wherein the end device comprises a peripheral device.

Example 15 includes the subject matter of any of Examples 11-14, and wherein the end device comprises a remote computing device.

Example 16 includes the subject matter of any of Examples 11-15, and further comprising: generating a bit-error rate diagram based on the bit-error rate data; wherein identifying the transmitter equalization setting comprises identifying the transmitter equalization setting based on the bit-error rate diagram.

Example 17 includes the subject matter of any of Examples 11-16, and wherein the first serial data link comprises an electrical backplane link.

Example 18 includes the subject matter of any of Examples 11-17, and wherein the first serial data link comprises a PCI Express lane, the second serial data link comprises a PCI Express lane, and the data port comprises a PCI Express port.

Example 19 includes the subject matter of any of Examples 11-18, and wherein the first serial data link comprises an Ethernet lane, the second serial data link comprises an Ethernet lane, and the data port comprises an Ethernet port.

Example 20 includes the subject matter of any of Examples 11-19, and wherein the transmitter equalization setting comprises a pre-cursor setting and a post-cursor setting.

Example 21 includes a computing device comprising: a processor; and a memory having stored therein a plurality of instructions that when executed by the processor cause the computing device to perform the method of any of Examples 11-20.

Example 22 includes one or more non-transitory, computer readable storage media comprising a plurality of instructions stored thereon that in response to being executed result in a computing device performing the method of any of Examples 11-20.

Example 23 includes a computing device comprising means for performing the method of any of Examples 11-20.

Example 24 includes one or more computer-readable storage media comprising a plurality of instructions stored thereon that, in response to being executed, cause a computing device to: connect a bit error rate test instrument (BERT) to a first serial data link of a retimer, wherein the retimer comprises the first serial data link, a second serial data link, a clock recovery device, and a signal repeater, wherein the signal repeater is coupled between the first serial data link and the second serial data link, and wherein the second serial data link is connected to a data port; cause the BERT to send a compliance pattern to the retimer via the first serial data link; cause the retimer to repeat the compliance pattern to the BERT via the first serial data link in a loopback mode; cause the BERT to transmit with a plurality of transmitter equalization settings while sending the compliance pattern; cause the BERT to measure bit-error rate data in response to transmitting with the plurality of transmitter equalization settings; and identify a transmitter equalization setting based on the bit-error rate data.

Example 25 includes the subject matter of Example 24, and wherein each of the first serial data link and the second serial data link comprises a transmit differential signaling pair and a receive differential signaling pair.

Example 26 includes the subject matter of any of Examples 24 and 25, and further comprising a plurality of instructions stored thereon that, in response to being executed, cause the computing device to: disconnect the BERT from the first serial data link; configure an end device with the transmitter equalization setting; and connect the end device to the first serial data link.

Example 27 includes the subject matter of any of Examples 24-26, and wherein the end device comprises a peripheral device.

Example 28 includes the subject matter of any of Examples 24-27, and wherein the end device comprises a remote computing device.

Example 29 includes the subject matter of any of Examples 24-28, and further comprising a plurality of instructions stored thereon that, in response to being executed, cause the computing device to: generate a bit-error rate diagram based on the bit-error rate data; wherein to identify the transmitter equalization setting comprises to identify the transmitter equalization setting based on the bit-error rate diagram.

Example 30 includes the subject matter of any of Examples 24-29, and wherein the first serial data link comprises an electrical backplane link.

Example 31 includes the subject matter of any of Examples 24-30, and wherein the first serial data link comprises a PCI Express lane, the second serial data link comprises a PCI Express lane, and the data port comprises a PCI Express port.

Example 32 includes the subject matter of any of Examples 24-31, and wherein the first serial data link comprises an Ethernet lane, the second serial data link comprises an Ethernet lane, and the data port comprises an Ethernet port.

Example 33 includes the subject matter of any of Examples 24-32, and wherein the transmitter equalization setting comprises a pre-cursor setting and a post-cursor setting.

1. A computing device for transmitter equalization configuration, the computing device comprising:
a data port;
a retimer that includes a first serial data link, a second serial data link, a clock recovery device, and a signal repeater, wherein the signal repeater is coupled between the first serial data link and the second serial data link, and wherein the second serial data link is connected to the data port; and
an equalizer configurator to: (i) connect a bit error rate test instrument (BERT) to the first serial data link of the retimer, (ii) cause the BERT to send a compliance pattern to the retimer via the first serial data link, (iii) cause the BERT to transmit with a plurality of transmitter equalization settings while sending the compliance pattern, (iv) cause the BERT to measure bit-error rate data in response to transmission with the plurality of transmitter equalization settings; and (v) identify a transmitter equalization setting based on the bit-error rate data;
wherein the retimer is to repeat the compliance pattern to the BERT via the first serial data link in a loopback mode in response to sending of the compliance pattern.

2. The computing device of claim 1, wherein each of the first serial data link and the second serial data link comprises a transmit differential signaling pair and a receive differential signaling pair.

3. The computing device of claim 1, wherein the equalizer configurator is further to:
disconnect the BERT from the first serial data link;
configure an end device with the transmitter equalization setting; and
connect the end device to the first serial data link.

4. The computing device of claim 3, wherein the computing device comprises the end device, and wherein the end device comprises a peripheral device.

5. The computing device of claim 3, wherein the end device comprises a remote computing device.

6. The computing device of claim 1, wherein the equalizer configurator is further to:
generate a bit-error rate diagram based on the bit-error rate data;
wherein to identify the transmitter equalization setting comprises to identify the transmitter equalization setting based on the bit-error rate diagram.

7. The computing device of claim 1, wherein the first serial data link comprises an electrical backplane link.

8. The computing device of claim 1, wherein the first serial data link comprises a PCI Express lane, the second serial data link comprises a PCI Express lane, and the data port comprises a PCI Express port.

9. The computing device of claim 1, wherein the first serial data link comprises an Ethernet lane, the second serial data link comprises an Ethernet lane, and the data port comprises an Ethernet port.

10. The computing device of claim 1, wherein the transmitter equalization setting comprises a pre-cursor setting and a post-cursor setting.

11. A method for transmitter equalization configuration, the method comprising:
connecting a bit error rate test instrument (BERT) to a first serial data link of a retimer, wherein the retimer comprises the first serial data link, a second serial data link, a clock recovery device, and a signal repeater, wherein the signal repeater is coupled between the first serial data link and the second serial data link, and wherein the second serial data link is connected to a data port;
sending, by the BERT, a compliance pattern to the retimer via the first serial data link;
repeating, by the retimer, the compliance pattern to the BERT via the first serial data link in a loopback mode;
transmitting, by the BERT, with a plurality of transmitter equalization settings while sending the compliance pattern;
measuring, by the BERT, bit-error rate data in response to transmitting with the plurality of transmitter equalization settings; and
identifying a transmitter equalization setting based on the bit-error rate data.

12. The method of claim 11, further comprising:
disconnecting the BERT from the first serial data link;
configuring an end device with the transmitter equalization setting; and
connecting the end device to the first serial data link.

13. The method of claim 12, wherein the end device comprises a peripheral device.

14. The method of claim 12, wherein the end device comprises a remote computing device.

15. The method of claim 11, further comprising:
generating a bit-error rate diagram based on the bit-error rate data;
wherein identifying the transmitter equalization setting comprises identifying the transmitter equalization setting based on the bit-error rate diagram.

16. The method of claim 11, wherein the transmitter equalization setting comprises a pre-cursor setting and a post-cursor setting.

17. One or more computer-readable storage media comprising a plurality of instructions stored thereon that, in response to being executed, cause a computing device to:
connect a bit error rate test instrument (BERT) to a first serial data link of a retimer, wherein the retimer comprises the first serial data link, a second serial data link, a clock recovery device, and a signal repeater, wherein the signal repeater is coupled between the first serial data link and the second serial data link, and wherein the second serial data link is connected to a data port;
cause the BERT to send a compliance pattern to the retimer via the first serial data link;
cause the retimer to repeat the compliance pattern to the BERT via the first serial data link in a loopback mode;
cause the BERT to transmit with a plurality of transmitter equalization settings while sending the compliance pattern;
cause the BERT to measure bit-error rate data in response to transmitting with the plurality of transmitter equalization settings; and
identify a transmitter equalization setting based on the bit-error rate data.

18. The one or more computer-readable storage media of claim 17, wherein each of the first serial data link and the second serial data link comprises a transmit differential signaling pair and a receive differential signaling pair.

19. The one or more computer-readable storage media of claim 17, further comprising a plurality of instructions stored thereon that, in response to being executed, cause the computing device to:
disconnect the BERT from the first serial data link;
configure an end device with the transmitter equalization setting; and
connect the end device to the first serial data link.

20. The one or more computer-readable storage media of claim 19, wherein the end device comprises a peripheral device.

21. The one or more computer-readable storage media of claim 19, wherein the end device comprises a remote computing device.

22. The one or more computer-readable storage media of claim 17, further comprising a plurality of instructions stored thereon that, in response to being executed, cause the computing device to:
generate a bit-error rate diagram based on the bit-error rate data;
wherein to identify the transmitter equalization setting comprises to identify the transmitter equalization setting based on the bit-error rate diagram.

23. The one or more computer-readable storage media of claim 17, wherein the first serial data link comprises an electrical backplane link.

24. The one or more computer-readable storage media of claim 17, wherein the first serial data link comprises a PCI Express lane, the second serial data link comprises a PCI Express lane, and the data port comprises a PCI Express port.

25. The one or more computer-readable storage media of claim 17, wherein the first serial data link comprises an Ethernet lane, the second serial data link comprises an Ethernet lane, and the data port comprises an Ethernet port.
